(19) United States
(12) Patent Application Publication
(10) Pub. No.: US 2009/0120278 A1
(43) Pub. Date: May 14, 2009

(54) ELECTROHYDROSTATIC ACTUATOR INCLUDING A FOUR-PORT, DUAL DISPLACEMENT HYDRAULIC PUMP

(76) Inventor: Dean R. Pollee, Mattawan, MI (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/265,494

(22) Filed: Nov. 5, 2008

Related U.S. Application Data
(60) Provisional application No. 60/986,056, filed on Nov. 7, 2007.

(51) Int. Cl. F15B 15/14; F15B 9/03; F15B 1/24; F15B 15/18

(52) U.S. Cl. 91/392; 60/374

(57) ABSTRACT

An electrohydrostatic actuator including an unbalanced area actuator whereby movement of an actuator piston causes a greater change in displacement on a first side of the actuator piston having a first area than on a second side of the actuator piston having a second area. The actuator includes a four-port, dual displacement hydraulic pump having a first pair of ports and a second pair of ports. If an axial piston pump is used, the pistons may be arranged in first and second rings of pistons arranged concentrically about a central axis. The pump has a port plate with a first pair of ports associated with the first ring of pistons and a second pair of ports associated with the second ring of pistons. At least one of the first pair of ports and at least one of the second pair of ports are connected to the first side of the actuator piston. At least one of the first pair of ports is connected to the second side of the actuator piston. At least one of the second pair of ports is connected to a reservoir of hydraulic fluid.

### FIELD OF THE INVENTION

The present invention relates generally to electrohydrostatic actuators and more particularly to the use of a four-port, dual displacement pump with an unbalanced area actuator.

### BACKGROUND

An electrohydrostatic actuator (EHA) is an actuator that is directed and powered a variable speed electric motor that is used to drive a hydraulic pump. The hydraulic fluid pressurized by the pump drives a piston in a cylinder for moving an actuator shaft. The actuator shaft, in turn, is mechanically connected to a mechanism being controlled.

Electrohydrostatic actuators may be configured several ways. Three of the ways are:
1) double ended (balanced area) cylinders;
2) single ended (unbalanced area) cylinders with logic valves to control the flow between cylinder and reservoir; and
3) single ended (unbalanced area) cylinders with a dual displacement, three-port pump.
   Each of these approaches are described below with their associated deficiencies.

FIG. 1 shows a balanced actuator 1 with an ordinary 2-port pump 2. Piston areas 3 and 4 are equalized by adding a tailstock 5 to a cylinder 6. This approach simplifies the pump and the associated hydraulic circuitry, but at an increased cost. This approach also adds extra length and weight to the actuator 1. Moreover, reliability may be reduced because of an incremental leak path related to an incremental rod seal 7. If configured as a tandem actuator, the unit becomes even longer, having two balanced cylinders plus the added tailstock length.

FIG. 2 shows one way to use valves to control an unbalanced flow between a cylinder and a reservoir. The valve shown responds to four modes of operation:

1) retracting motion with opposing load;

2) retracting motion with aiding load;

3) extending motion with opposing load; and

4) extending motion with aiding load.

While the advantages of an unbalanced area cylinder and simple 2-port pump are realized, this scheme has several drawbacks. One problem is that the switching valve is costly due to the fast response and low leakage required. Other problems include: reduced dynamic actuator stiffness, the potential for causing instability in control loops, the potential for adverse impact to EHA performance (e.g., threshold, frequency response, heat rejection), and the fact that the ratio of actuator shaft speed to pump RPM is dependent on the direction of motion.

FIG. 3 shows an actuator 10 that uses a 3-port pump 11 with a single set of pistons. This configuration allows use of unbalanced areas 12 and 13 with a relatively simple pump. The location of a split 14 between a pair of ports, C₂ and C₃, determines the flow ratio. A portion of the pump piston stroke equal to that of the flow ratio (area 12/area 13) is used on port C₂, while the remainder is used on port C₃. Another port C₁ uses the entire stroke.

Splitting a port into two ports, C₂ and C₃, as shown in FIG. 3 has many undesirable ramifications. One problem is that at the transition or split 14 between ports C₂ and C₃, the pump piston speed may retain 70% to 80% of its maximum velocity (depending on the design flow ratio). As a cylinder barrel port commutates across the C₂-C₃ split 14, it is instantaneously blocked off. If that particular piston is on an intake stroke, a momentary vacuum is drawn on the fluid causing vapor and gas bubbles to form. After the transition is crossed, the bubbles collapse and may cause cavitation damage to internal pump components such as the barrel porting. On the other hand, if that particular piston is on a discharge stroke, extreme over-pressure can occur inside the barrel because the flow is momentarily blocked from exiting the cylinder barrel. Therefore, the barrel must be designed to withstand the resulting stresses for the designed fatigue life of the pump components. Such designs may impose a weight penalty. Both of these problems are aggravated with increasing RPM and become the limiting factors for maximum pump speed. Accordingly, a larger, heavier, slower turning pump may be required.

The pressure extremes discussed above can cause another problem in that they carry over into the next port, thus causing the actual flow ratio of the pump to drift. For example, assume port C₂ is currently acting as an inlet. Because the porting is temporarily blocked near the transition to port C₃, not all the flow returning from the actuator cylinder makes it back through the pump, causing an effect called “pressure pump-up” in the actuator. Once at port C₃, fluid rushes in to fill the void of vapor bubbles. During opposite rotation, port C₃ will be acting as an outlet, but because of the port blockage, the fluid is over-compressed. Once at the C₂ port, the high pressure fluid expands causing an excess of flow going to the actuator, and once again, the “pump-up” effect occurs. However, by using a mirror image pump cam, the “pump-up” effect can be transformed into a “pump-down” effect. These effects necessitate the use of anti-cavitation check valves 15. The pressure spikes have been known to noticeably reduce pump efficiency because of increased loading between internal components.

To help alleviate these problems, porting under-lap is incorporated at the C₂-C₃ transition zone. The under-lap allows some leakage between the two ports. Although the under-lap helps with the aforementioned problems, it imposes a penalty on pump volumetric efficiency, which in turn aggravates actuator heat rejection. Designing a numerically low flow ratio into the port plate makes these issues worse. The issues worsen because the piston velocity at the transition zone increases when the flow ratio decreases. Therefore, pressure ripple from the C₃ port may be quite high and cause fatigue and component damage in the actuator manifold. With typical flow ratios, only one piston is connected with this port at a time, causing a highly pulsating flow.

### SUMMARY OF THE INVENTION

The invention solves these problems by using a four-port, dual displacement hydraulic pump with unbalanced area EHA's (Electro-Hydrostatic-Actuators) and EBHA's (Electro-Backup-Hydrostatic-Actuators). The pump may be a 4-port pump that utilizes dual rows or rings of pistons to achieve the dual displacement characteristic desirable for unbalanced area actuators. The 4-port pump eliminates many of the previously mentioned problems because all port transitions occur at bottom and top dead center of piston travel, where piston velocity is zero. With such a pump it is possible to design for a wider range of flow ratios, including low ratios. Additionally, it may be possible to operate the pump at higher speeds, resulting in a weight savings not just in the pump, but also manifested in a smaller, lower torque, higher speed electric drive motor.

One aspect of the invention provides an electrohydrostatic actuator including an actuator having a cylinder and a piston movable in the cylinder. The actuator is an unbalanced actuator whereby movement of the actuator piston causes a greater change in displacement on a first side of the actuator piston having a first area than on a second side of the actuator piston having a second area. The electrohydrostatic actuator also includes a hydraulic pump having a first pair of ports and a second pair of ports. At least one of the first pair of ports and at least one of the second pair of ports are fluidly connected to the first side of the actuator piston. At least one of the first pair of ports is fluidly connected to the second side of the actuator piston. At least one of the second pair of ports is fluidly connected to a reservoir of hydraulic fluid.

Another aspect of the invention provides an electrohydrostatic actuator wherein the hydraulic pump is an axial piston hydraulic pump having two pluralities of pistons arranged about a central axis at two different radii. The first pair of ports is associated with the first plurality of pistons and the second pair of ports is associated with the second plurality of pistons.

Another aspect of the invention provides an electrohydrostatic actuator wherein the ratio of the displacement of the port fluidly connected to the second side of the actuator piston to the displacement of the ports fluidly connected to the first side of the actuator piston is generally equivalent to the ratio of the area of the second side of the piston to the area of the first side of the piston.

Another aspect of the invention provides an electrohydrostatic actuator including an actuator including a cylinder and a piston movable in the cylinder, the actuator being an unbalanced actuator whereby movement of the piston causes a greater change in volume on a first side of the piston than on a second side of the piston. The electrohydrostatic actuator also includes a pump having two pluralities of pistons arranged about a central axis at different diameters. Two ports are associated with the first plurality of pistons and two ports are associated with the second plurality of pistons. Three conduits provide fluid communication between the ports and the two sides of the pistons and a reservoir.

Another aspect of the invention provides an electrohydrostatic actuator wherein the pump is drivable in one direction to pump hydraulic fluid from the first side of the piston through the first conduit and through the second conduit to the second side of the actuator piston and from the first side of the actuator piston through the first conduit and through the third conduit to the reservoir. Moreover, the pump is drivable in an opposite direction to pump hydraulic fluid from the second side of the actuator piston through the second conduit and through the first conduit to the first side of the actuator piston and from the reservoir through the third conduit and through the first conduit to the first side of the actuator piston.

Another aspect of the invention provides an electrohydrostatic actuator including a cylinder and a 4-port pump. The cylinder includes a piston slidably disposed within the cylinder having a first side and a second side and a ram secured to the piston for extending from the cylinder. The pump includes a cylinder barrel having a first ring of cylinders having pistons slidably disposed therein and a second ring of cylinders having pistons slidably disposed therein wherein the first ring of cylinders has a first diameter and the second ring of cylinders has a second diameter. The pump also includes a port plate having a first plurality of ports in communication with the first ring of cylinders and a second plurality of ports in communication with the second ring of cylinders. Additionally, the ports of the pump are associated with specific portions of the actuator. One of the first plurality of ports and one of the second plurality of ports are in communication with the first side of the actuator piston. One of the first plurality of ports is in communication with the second side of the actuator piston. One of the second plurality of ports is in communication with a reservoir.

The foregoing and other features of the invention are hereinafter fully described and particularly pointed out in the claims, the following description, and the annexed drawings setting forth in detail one or more illustrative embodiments of the invention, such being indicative, however, of but one or a few of the various ways in which the principles of the invention may be employed.

### BRIEF DESCRIPTION OF THE DRAWINGS

FIG. 1 is a schematic view of a prior art balanced area actuator with a tailstock.

FIG. 2 is a schematic view of a prior art unbalanced area actuator with additional ports for four modes of operation.

FIG. 3 is a schematic view of a prior art unbalanced area actuator with a 3-port pump.

FIG. 4 is a cross-sectional view of a prior art 2-port pump configured to provide variable displacement by adjusting the swashplate angle.

FIG. 5 is a schematic view of an unbalanced area actuator with a 4-port pump in accordance with the present invention.

FIGS. 6A and 6B show perspective views of a port plate configuration of the 4-port pump shown in FIG. 5.

FIGS. 7A and 7B show perspective views of a cylinder barrel of the 4-port pump shown in FIG. 5.

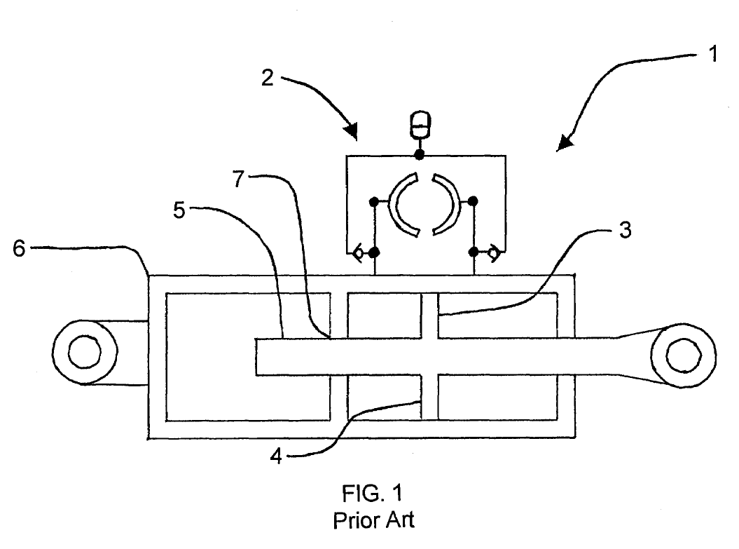

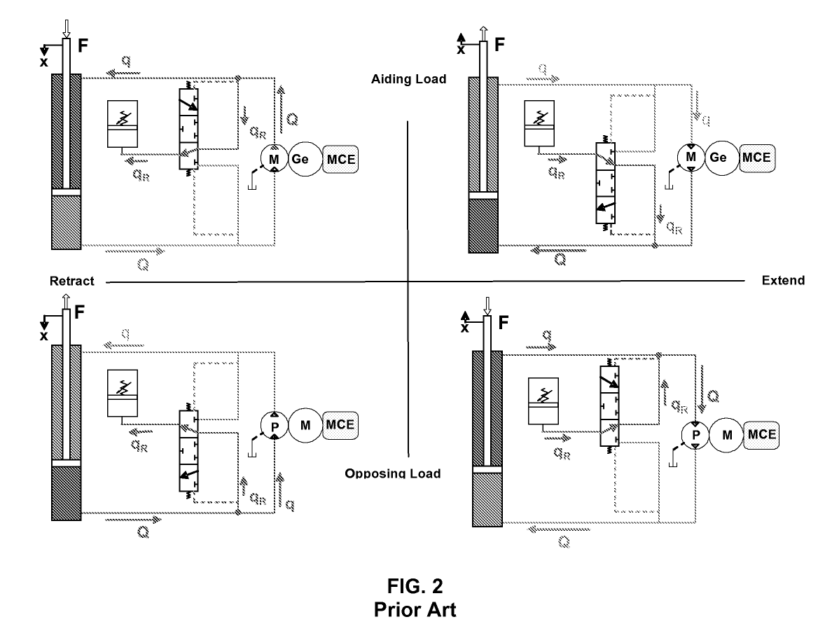

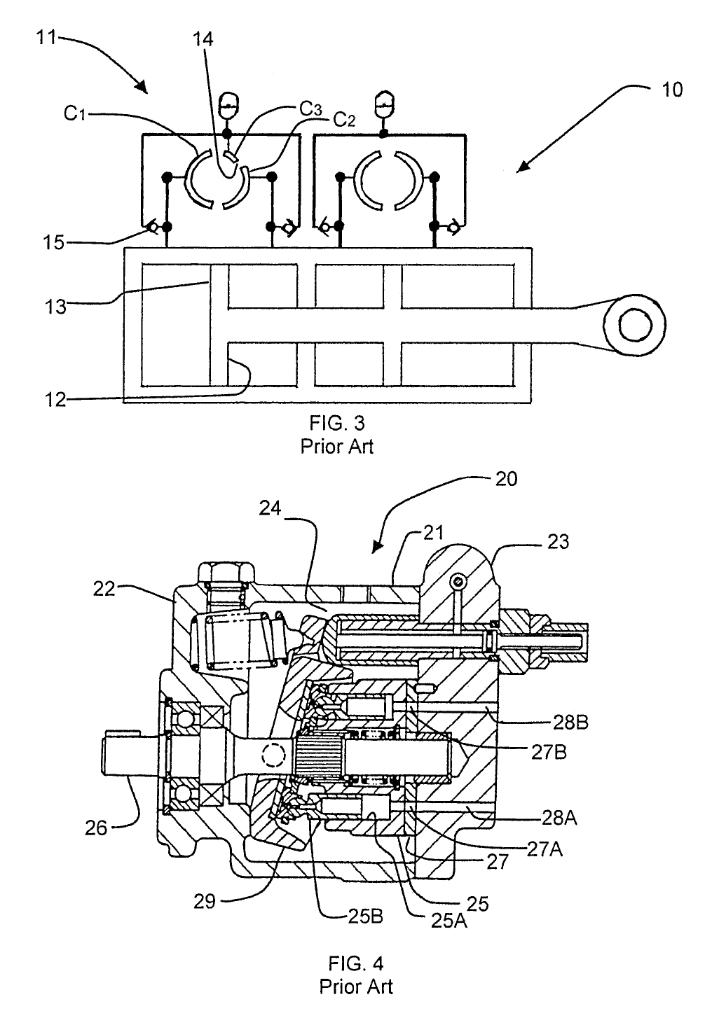

### DETAILED DESCRIPTION

As shown in FIG. 4 of the drawings, a conventional 2-port variable displacement piston pump 20 includes a housing 21 composed of a housing body 22 closed by an end wall block 23 secured thereto in a fluid-tight manner to form therein a cavity 24 to be filled with hydraulic fluid. Disposed within the housing cavity 24 is a rotary cylinder barrel 25 that is splined to a drive shaft 26 rotatably mounted within the housing 21. The cylinder barrel 25 is formed with a plurality of circumferentially equally spaced cylinders 25A in which a corresponding number of pistons 25B are axially slidably disposed for reciprocation. The cylinder barrel 25 is axially movable on the drive shaft 26 and has a forward end face in slidable contact with a port plate 27 under the load of a compression coil spring supported thereon. The port plate 27 is secured in place to an internal surface of the end wall block 23, the port plate being formed with a semi-circular intake slot 27A and a semi-circular discharge slot 27B respectively in open communication with inlet and outlet passages 28A and 28B in the end wall block 23. The intake and discharge slots 27A and 27B are arranged to communicate with the barrel cylinders 25A for intake and discharge operation of hydraulic fluid. An inclined swash plate 29 is tiltably supported at its opposite sides on the housing body 22 for frictional engagement with shoes coupled with each spherical head of the plurality of pistons 25B. During rotation of the cylinder barrel 25, frictional engagement of the piston shoes on the inclined swash plate 29 causes pumping action by reciprocating the pistons 25B in the barrel cylinders 25A. In the variable displacement pump of FIG. 4, the angle of the swashplate 29 may be adjusted to provide a different pump displacement at the same rotation speed.

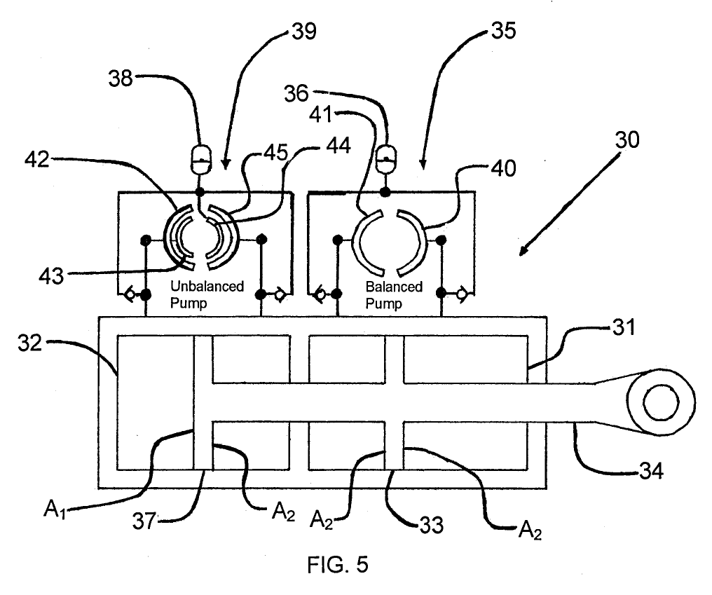

FIG. 5 shows a simplified schematic representation of a dual-tandem actuator 30 in accordance with the invention. The actuator 30 has a right hand cylinder 31 and a left hand cylinder 32. The right-hand cylinder 31 includes a piston 33 having equal areas A₂ on both of its sides. The actuator 30 includes a ram 34 extending from the right hand side. A simple 2-port pump 35 with equal displacement in either direction suffices to transfer fluid from one side of the piston 33 to the other to force the actuator to move. There is no net transfer of fluid between the cylinder chambers and a reservoir 36.

The left hand cylinder 32, however, has differential piston areas A₁ and A₂ on each side of a piston 37. If the ram 34 is extending, fluid must be transferred from a reservoir 38 into the cylinder 32 and vice versa. This fluid transfer is normally across a pressure difference, so a simple connection to the reservoir 38 is not sufficient. A dual-displacement pump 39 described herein performs this function.

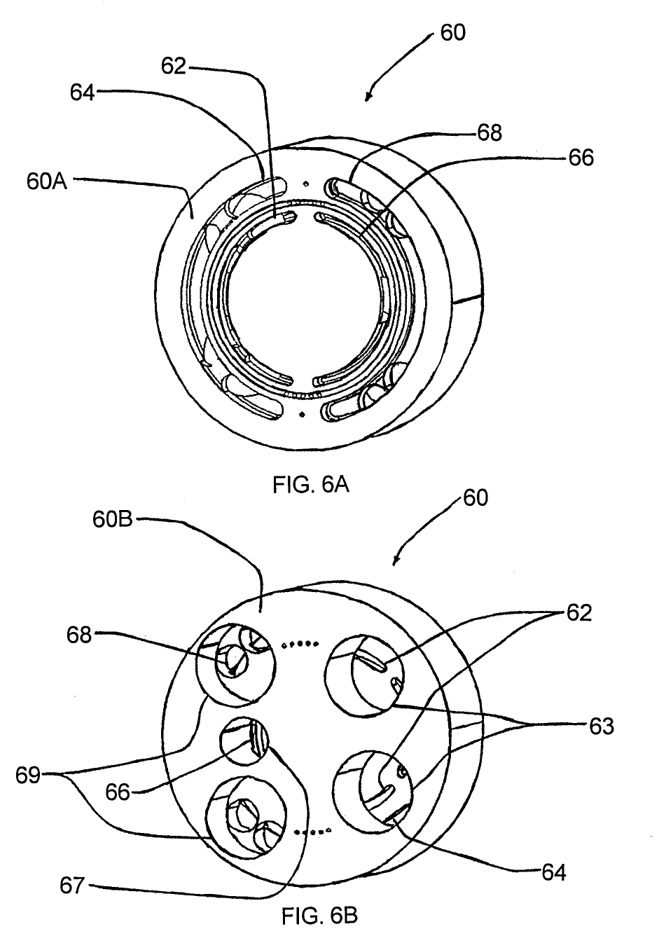

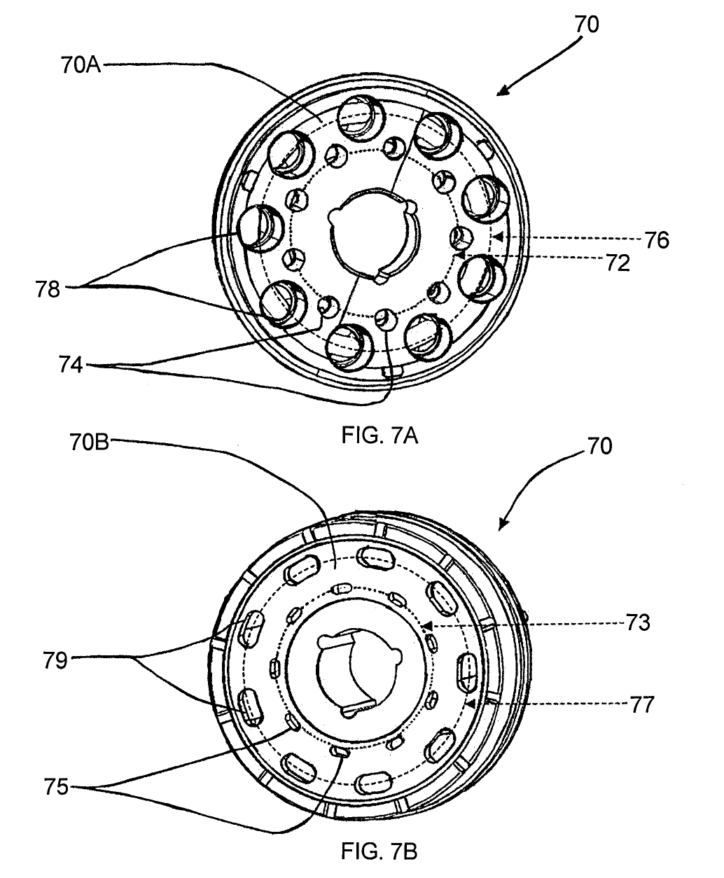

In FIG. 5, the pumps 35 and 39 are depicted as representations of their fluid commutation ports (typically called port plates). For the 2-port pump 35 there are two ports 40 and 41. For a given direction of shaft rotation, one port will be an outlet and the other an inlet. Reversed shaft rotation reverses the direction of the flow. The dual displacement pump 39 has four ports 42, 43, 44 and 45, two ports for each of two concentric rows of pistons. FIGS. 6A, 6B, 7A and 7B further illustrate the geometry. As FIG. 5 shows, the two ports on the left, 42 and 43, are plumbed together and connect to an A₁ side of the actuator piston 37. The outer right-hand port 45 connects to an A₂ side of the piston 37, and the inner right-hand port 44 is connected to the reservoir 38.

During cylinder extension, fluid from both left-hand ports 42 and 43 supply oil to the A₁ side of the actuator piston 37. The outer right-hand port 45 receives flow returning from the A₂ side of the actuator, and the inner right-hand port 44 receives inlet flow from the reservoir 38. Thus, the pump 39 causes a net transfer of fluid from the reservoir 38 into the left hand actuator cylinder 32.

During cylinder retraction, the pump 39 rotates in the opposite direction and the ports function in a reverse manner. The pump 39 passes a portion of the cylinder return flow back to the reservoir 38.

For proper operation, the ratio of port displacements should approximate the ratio of actuator piston areas A₁ and A₂. This ratio, A₂ divided by A₁, is defined as the pump's “flow ratio” and is generally in the range of 0.8 to 0.9. In the following equation, D₄₂, D₄₃, D₄₄, and D₄₅ represent the displacements (e.g. cc per revolution) associated with each respective port:

$$\frac{{D}_{45}}{{D}_{42} + {D}_{43}} = \frac{{A}_{2}}{{A}_{1}}$$

Since D₄₂+D₄₃=D₄₅+D₄₄, the displacement associated with the reservoir may be written as:

$${D}_{44} = ( 1 - {A}_{2} / {A}_{1} ) ( {D}_{42} + {D}_{43} )$$

The port plate and barrel cylinders shown in FIGS. 6A, 6B, 7A, and 7B are based on a flow ratio of 0.85, which is typical for an actuator area ratio. This configuration allows for clearance between adjacent piston shoes (not shown).

Turning to FIGS. 6A and 6B, an exemplary port plate 60 in accordance with the invention is shown. The port plate 60 has faces 60A and 60B. Face 60A is shown in FIG. 6A. Face 60B is shown in FIG. 6B. Turning to FIG. 6A, the left portion of face 60A is broken by two semi-circular ports: inner port 62 and outer port 64. When port plate 60 is used in the dual-displacement pump 39 of FIG. 5, the inner port 62 of FIG. 6A corresponds to the inner port 43 of FIG. 5. The outer port 64 of FIG. 6A corresponds to the outer port 42 of FIG. 5. As shown in FIG. 5, the inner and outer ports are plumbed together to supply oil to and receive oil from the left hand cylinder 32 in communication with the A₁ side of the piston 37. Turning back to FIG. 6A, the right portion of face 60A is broken by two semi-circular ports: inner port 66 and outer port 68. When port plate 60 is used in the dual-displacement pump 39 of FIG. 5, the inner port 66 of FIG. 6A corresponds to the inner port 44 of FIG. 5. The outer port 68 of FIG. 6A corresponds to the outer port 45 of FIG. 5. As shown in FIG. 5, the inner port 44 (and corresponding inner port 66 of FIG. 6A) is plumbed to the reservoir 38. The outer port 45 (and corresponding outer port 68 of FIG. 6A) is plumbed to supply oil to and receive oil from the cylinder 31 in communication with the A₂ side of the piston 37.

Turning to FIG. 6B, the opposite face 60B of the port plate 60 is shown with the reverse side ports 62, 64, 66, 68 routed or plumbed as noted above. On the right hand portion of face 60B (which corresponds to the left hand portion of the face 60A), two circular plumbing ports 63 are shown that are both in communication with inner and outer ports 62 and 64. On the left hand portion of face 60B (which corresponds to the right hand portion of the face 60A), one inner circular plumbing port 67 is shown in communication with inner port 66. Two outer circular plumbing ports 69 are in communication with outer port 68.

Typical materials for the port plate 60 include hardened steel.

Turning now to FIGS. 7A and 7B, an exemplary cylinder barrel 70 in accordance with the invention is shown. The cylinder barrel 70 has faces 70A and 70B. Face 70A is shown in FIG. 7A. Face 70B is shown in FIG. 7B. Turning to FIG. 7A, face 70A is shown with two rings of cylinders: an inner ring 72 comprising nine cylinders 74 and an outer ring 76 comprising cylinders 78.

Turning to FIG. 7B, the opposite face 70B of the cylinder barrel 70 is shown with the inner and outer rings of cylinders 72 and 76 in corresponding communication with an inner ring of ports 73 comprising elongated ports 75 and an outer ring of ports 77 comprising elongated ports 79.

Typical materials for the cylinder barrel 70 include bronze, bronze plated steel, and cast iron. Additionally, it is noted that the invention is in no way limited to the number of cylinder bores noted in the example herein. Any number of cylinders per ring may be used, depending on the size of the pump and the application.

When the cylinder barrel 70 and the port plate 60 are assembled in a pump assembly (such as that shown in FIG. 4), face 60A of port plate 60 shown in FIG. 6A is mated with face 70B of the cylinder barrel 70 shown in FIG. 7B. When so configured, the inner ring of elongated ports 73 is in communication with the inner semi-circular ports 62 and 66 of face 60A. The outer ring of elongated ports 77 is in communication with outer semi-circular ports 64 and 68 of face 60A. When the pistons (not shown) are in sliding reciprocal communication with the cylinders 74 and 78, the pistons displace oil into or receive oil from elongated ports 75 and 79 respectively. Elongated ports 75 and 79, in turn, supply oil to or receive oil from their respective mating semi-circular inner ports 62 and 66 or outer semi-circular ports 64 and 68 of the port plate 60. The inner and outer ports are in communication for supplying or receiving oil from the cylinder or the reservoir as discussed above with respect to FIG. 5.

Referring back to FIG. 4, the port plate 60 and cylinder barrel 70 may be assembled into a pump in the manner shown in the 2-port pump 20 of FIG. 4. Cylinder barrel 70 replaces original cylinder barrel 25 and port plate 60 replaces original port plate 27. When assembled with the proper number of pistons for the two concentric rings of cylinders and properly plumbed with new inlet and outlet passages (to replace 28A and 28B), the newly configured 4-port pump forms an example of pump 39 of FIG. 5. Please note that the variable angle swashplate of FIG. 4 is not essential to the invention.

Additionally, it is noted that the invention is not limited to the axial piston pump of the example herein. Any dual displacement pump having four outlets and inlets may be used. Examples of such alternative pumps include: a gear pump with one large gear pair and one small gear pair or a vane pump having two adjacent chambers of different sizes.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electrohydrostatic actuator comprising:
an actuator including a cylinder and an actuator piston movable in the cylinder, the actuator being an unbalanced actuator whereby movement of the piston causes a greater change in displacement on a first side of the piston having a first area than on a second side of the piston having a second area;
a hydraulic pump comprising:
a first pair of ports; and
a second pair of ports;
wherein at least one port of the first pair of ports and at least one port of the second pair of ports are fluidly connected to the first side of the actuator piston;
wherein at least one port of the first pair of ports is fluidly connected to the second side of the actuator piston; and
wherein at least one port of the second pair of ports is fluidly connected to a reservoir of hydraulic fluid.

2. The electrohydrostatic actuator of claim 1, wherein the hydraulic pump comprises an axial piston hydraulic pump further comprising:
a first plurality of pistons arranged about a central axis at a first radius;
a second plurality of pistons arranged about the central axis at a second radius different from the first radius;
wherein the first pair of ports is associated with the first plurality of pistons; and
wherein the second pair of ports is associated with the second plurality of pistons.

3. The electrohydrostatic actuator of claim 2, wherein a ratio of the displacement of the port fluidly connected to the second side of the actuator piston to the displacement of the ports fluidly connected to the first side of the actuator piston is equivalent to a ratio of the area of the second side of the actuator piston to the area of the first side of the actuator piston.

4. The electrohydrostatic actuator of claim 1, wherein the hydraulic pump comprises a vane pump.

5. The electrohydrostatic actuator of claim 1, wherein the hydraulic pump comprises a gear pump.

6. An electrohydrostatic actuator comprising:
an actuator including a cylinder and an actuator piston movable in the cylinder, the actuator being an unbalanced area actuator whereby movement of the piston causes a greater change in volume on a first side of the actuator piston than on a second side of the actuator piston;
a pump including:
a first plurality of pistons arranged about a central axis at a first radius and a second plurality of pistons arranged about the central axis at a second radius;
a first and second port associated with the first plurality of pistons and a third and fourth port associated with the second plurality of pistons;
a first conduit for providing communication between the first port and the third port and the first side of the actuator piston;
a second conduit for providing communication between the second port and the second side of the actuator piston; and
a third conduit for providing communication between the fourth port and a reservoir.

7. The electrohydrostatic actuator of claim 6, wherein
the pump is drivable in one direction to pump hydraulic fluid from the first side of the actuator piston through the first conduit and through the second conduit to the second side of the actuator piston and from the first side of the actuator piston through the first conduit and through the third conduit to the reservoir; and
the pump is drivable in an opposite direction to pump hydraulic fluid from the second side of the actuator piston through the second conduit and through the first conduit to the first side of the actuator piston and from the reservoir through the third conduit and through the first conduit to the first side of the actuator piston.

8. An electrohydrostatic actuator comprising:
a cylinder comprising:
an actuator piston slidably disposed within the cylinder having a first side and a second side; and
a ram secured to the actuator piston for extending from the cylinder;
a 4-port pump comprising:
a cylinder barrel having a first ring of cylinders having pistons slidably disposed therein and a second ring of cylinders having pistons slidably disposed therein wherein the first ring of cylinders has a first diameter and the second ring of cylinders has a second diameter;
a port plate having a first plurality of ports in communication with the first ring of cylinders and a second plurality of ports in communication with the second ring of cylinders;
wherein one of the first plurality of ports and one of the second plurality of ports are in communication with the first side of the actuator piston;
wherein one of the first plurality of ports is in communication with the second side of the actuator piston; and
wherein one of the second plurality of ports is in communication with a reservoir.
